(19) United States
(12) Patent Application Publication
(10) Pub. No.: US 2014/0192510 A1
(43) Pub. Date: Jul. 10, 2014

(54) FOLDABLE SOFT BOX

(71) Applicant: Jong Seok Kim, Busan (KR)

(72) Inventor: Jong Seok Kim, Busan (KR)

(21) Appl. No.: 14/237,260

(22) PCT Filed: Oct. 8, 2012
(86) PCT No.: PCT/KR2012/008115

§ 371 Date: Feb. 5, 2014

(30) Foreign Application Priority Data
Oct. 20, 2011 (KR) 10-2011-0107504

(51) Int. Cl. G03B 15/06

(52) U.S. Cl. CPC G03B 15/06
USPC 362/16

(57) ABSTRACT

A foldable soft box includes a housing in which a hollow portion is formed in the central part thereof, a plurality of insertion grooves are radially formed on the front side thereof, and a rotation space is formed on the inner side thereof; a plurality of support bars which are rotatably connected to the housing such that the plurality of the support bars are selectively inserted into the insertion grooves; a rotary control unit which is rotatably disposed in said turning space; and a lamp fixing unit which is coupled with said hollow portion, and fixes a light-emitting lamp.

### FIELD OF THE INVENTION

The disclosure of the present invention herein relates to a soft box and more particularly to a foldable soft box with excellent operability in terms of portability and storage.

### BACKGROUND ART

Electronic flash is flash equipment used to take clear and distinct pictures of the subject at night or when the subject is situated indoors. It is used as an additional light source to natural or artificial light during photography session as it can be used in various forms installed either at the inner or the outer part of the camera.

Electronic flash located at the outer part of the camera can be classified in terms of light exposure according to the function of the lighting, preference or the photographic technique of the user. One of the methods is to shine the light from the light emitting lamp directly on the subject. Another method is to attach the soft box or other devices in order to diffuse the light.

During this process, direction of the diffusing light and its quality is determined which in turn enables the camera to take pictures with good quality and clear color tones.

FIG. 1 is the side elevation view of the soft box of the prior art. As it is shown on FIG. 1, soft box of prior art includes housing, reflective material, and a support bar.

As it is illustrated, soft box from prior art has a light-emitting lamp and the mounting post which enables it to adjust the height.

More specifically, soft box of prior art is equipped with housing in which the light-emitting lamp can be attached. As for the housing that had been mentioned above, plurality of support bars are attached to the hinge in order for it to fold or to unfold. As for the support bar, reflective material is attached in order to diffuse the light from the light-emitting lamp.

Moreover, diffuser made from felt or a mesh is located in front of the reflective material which is in shape of an umbrella in order to control the amount of light exposure.

Therefore, the light refraction and diffusion takes place with the light produced from the light-emitting lamp in accordance with the direction of reflective material from the soft box.

The light that had been induced in this manner passes through two diffuser materials to shine the delicate light on the subject wherein it is used to produce clear pictures of the subject.

On the other hand, fastening ring of the connecting rod is placed at the front part of the housing in the center.

The fastening ring of the connecting rod and plurality of supporting rods are connected through the connecting rod.
It is shown that the connecting rod, fastening ring of the connecting rod and support bars are structured in the same manner as a foldable umbrella.

However, soft box of the prior art as illustrated above have following technical problems.

First, light coming from the light-emitting lamp is blocked by connecting rod joined at center part of the support bar with the fastening ring connected at the end of it. This in turn results in great loss of light quantity which causes problem in photography session as this makes it difficult to secure the deep depth of field.

Furthermore, problem regarding the front part of light-emitting lamp getting scratched by the fastening ring of the connecting rod at the end of the connecting rod when the soft box is being folded or unfolded.

Moreover, as size of the soft box becomes bigger, weight of the connecting rod and its fastening ring increases; thus the soft box becomes less portable as it becomes difficult to store, move or manage due to its increased size.

### DETAILED DESCRIPTION

### Technical Problem

Accordingly, the present invention has been made in view of the above mentioned problems occurring in the prior art and it is the object of the present invention to provide foldable soft box with excellent operability in terms of portability and storage.

### Technical Solution

The present invention has been made in view of the above mentioned problems occurring in the prior art, and it is an object of the present invention to provide a foldable soft box comprising: a housing in which a hollow portion is formed in the central part thereof, a plurality of insertion grooves are radially formed on the front side thereof, and a turning space is formed on the inner side thereof; a plurality of support bars which are rotatably connected to said housing such that the plurality of the support bars are selectively inserted into said insertion grooves, wherein a body fabric having a reflective layer on an inner side thereof is fixed to the plurality of support bars; a rotary control unit which is rotatably disposed in said turning space, wherein the rotary control unit has hooks which are elastically supported by elastic springs that are disposed in guide grooves formed on the inner side of said housing and selectively control said support bars inserted into said insertion grooves; and a lamp fixing unit which is coupled with said hollow portion, and fixes a light-emitting lamp.

Rotary control unit is put in place in order to move in circumferential direction of the turning space as it had been mentioned above. It rotates along with the rotation of the rotating part. It is advisable for it to be structured with hook extension with the protruding hook in one side.

Long hole is formed at the back side of the housing for the fixed knob to penetrate as well as rotate. It is advisable that protruding knob and protruding fixed knob in the opposite direction to be placed on the rim of the long hole.

Moreover, one side of the support bar and the housing is connected by the resilient member. When the support bar is freed from restriction, it is advisable for snapping and folding action to take place.

On the other hand, lamp fixing unit can be selectively connected and also detachable through the fastener at the back part of the housing. It is advisable that the structure consists of the base where rim of the installed hole is formed which corresponds to front part of the lamp located at the center, fixed hollow portion placed at both sides of the base wherein the high pressure screw is fastened to the fastening hole, and including the support frame that had been designed to selectively fold in the fixed equipment which is installed in the lower part of the mounting post and the high part is fastened to be detachable as it is inserted in the fixed hollow portion.

### Advantageous Effects of Invention

Following effects will be provided according to the present invention as technical solution.

Firstly, the support bar can either be restricted or become free from restriction through the rotary control unit within the housing wherein deep depth of field as well as clear and high quality lighting will be provided as there are no additional parts blocking the light from the light-emitting lamp in the inner part of the support bar considering the fact that the support bar is either restricted or freed from restriction through the rotary control unit. As rotary control unit that restricts the support bar is placed within the housing without taking up too much space, it is easier to store and has increased portability.

Second, as support bar can be easily folded and stored through the restoring force of the resilient member as protruding knob within the housing can be easily be manipulated to free the support bar from restriction as this greatly improves the portability and the function regarding the storage.

Thirdly, light-emitting lamps can be used interchangeably according to the shape of the front part as plurality of bases with installation holes with various border fasteners according to the type of light-emitting lamp are provided.

### BRIEF DESCRIPTION OF DRAWINGS

FIG. 1 is a side view of the soft box of the prior art.

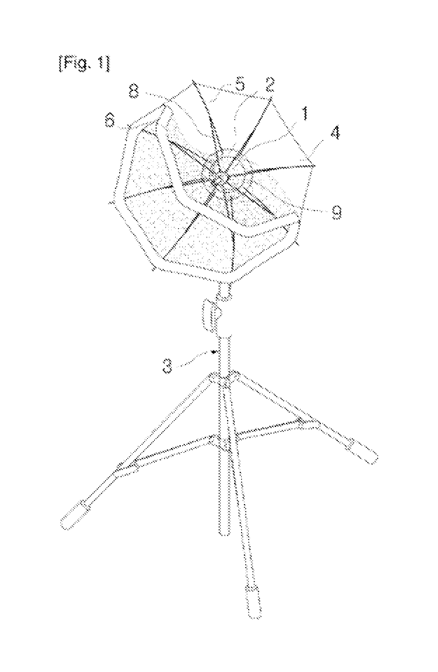

FIG. 2 is a side view of the foldable soft box according to embodiment of the present invention.

FIG. 3a is a front side view of the main features of the foldable soft box according to embodiment of the present invention.

FIG. 3b is a back side view of the main features of the foldable soft box according to embodiment of the present invention.

FIG. 4 is the exploded view from the side of the foldable soft box according to embodiment of the present invention.

FIGS. 5a and 5b is the restricted state and the disassembled state of the support bar as based on the A-A′ direction from FIG. 3.

### BEST MODE

Embodiments of the present invention will be described below in more detail with reference to the accompanying drawings.

### Description of Embodiments

Hereinafter, exemplary embodiments of the present invention will be described in detail with reference to the accompanying drawings.

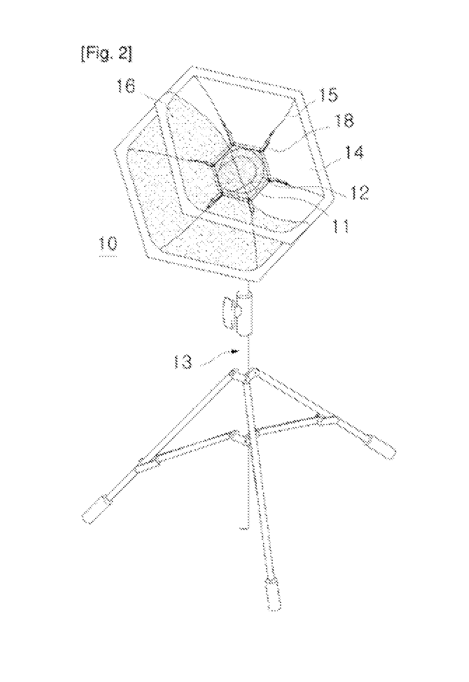

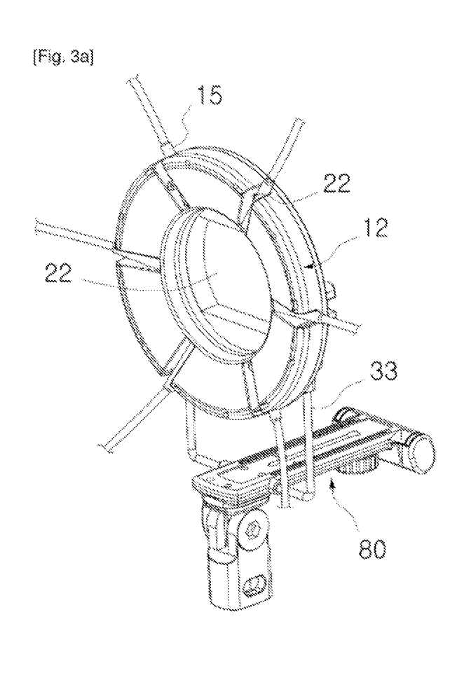

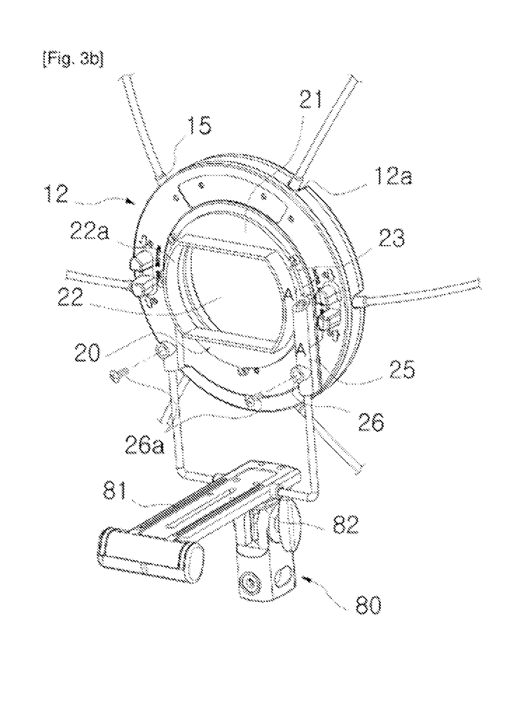

FIG. 2 is a side view of the foldable soft box according to the embodiments of the present invention. FIG. 3a is a front side view of the main features of the foldable soft box according to embodiment of the present invention. FIG. 3b is a back side view of the main features of the foldable soft box according to embodiment of the present invention.

FIG. 2 and FIG. 3b illustrates, foldable soft box 10 is placed on top of the mounting post 13 wherein it enables the photographic session to produce clear and distinct pictures as the light from the light-emitting lamp 11 is diffused in certain direction.

For this purpose, foldable soft box includes housing 12, plurality of support bars 15, rotary control unit and lamp fixing unit.

Housing 12 has a hollow portion 22 formed at the central part and plurality of insertion grooves 12a are radially formed on the front side thereof and space for rotation is formed on the inside. Plurality of support bars 15 are connected to the housing 12 in order to be rotated so that it may selectively inserted to the insertion grooves 12a wherein reflective body fabric 14 is fastened in the inner part of the plurality of support bars 15 placed radially.

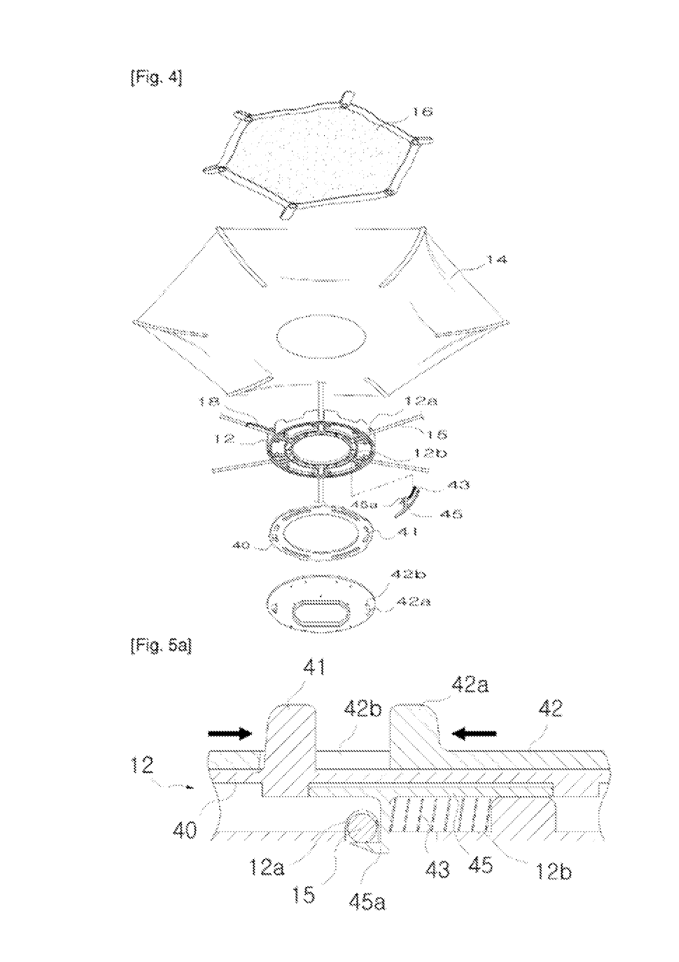

FIG. 4 is the exploded view of the foldable soft box according to the embodiment of current invention.

As seen on FIG. 4, rotary control unit is placed in the inner part of the housing 12 in the rotating space in order for making it possible to rotate wherein the elastic spring 43 inserted in the guide groove 12b wherein it is elastically supported with the elastic spring 43 wherein the hook 45a is included with the supporting bars 15 inserted within the insertion grooves 12a.

Side of the support bar 15 and the housing 12 is connected by elastic part (18 of FIG. 2) wherein the folding action should ideally be carried out by restoring force of the elastic part 18.

Moreover, when the support bars 15 are restricted by the hook 45a, it maintains to be spread out and when the restriction is freed, support bars 15 will be folded with the restoring force of the elastic part 18 such as rubber band or springs which connects the support bar 15 and housing 12.

More specific explanation regarding rotary control unit according to the present embodiment of the invention are as follows.

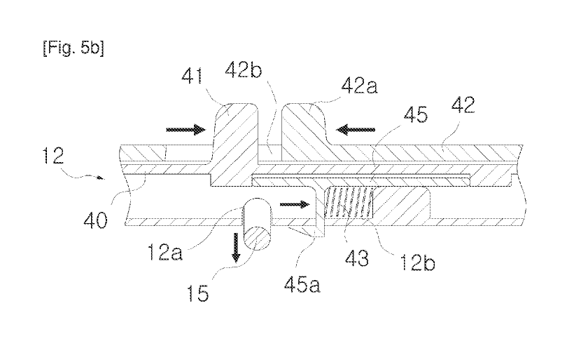

FIGS. 5a and 5b is the restricted state and the disassembled state of the support bar as based on the A-A′ direction from FIG. 3.

As it is seen in FIG. 4 and FIG. 5b, rotary control unit consists of rotating part 40 and hook extension part 45. Rotary control unit 40 consists of circular arc formation so that it may be possible for it to move according to the circumference in the rotation area within the housing 12. On the back side, protruding knob 41 is placed on the outside of the housing 12. It is advisable for the rotating part 40 with the ring shape that selectively restrict the support bars that matches each hook extension 45 wherein the hook extension is placed radially circumferential direction with the distance measured in predetermined angle.

The rotating space may be formed on the side instead of inner space of the housing 12 and there may be plurality of rotating parts formed when separated in circular forms.

In case where there is plurality of rotating parts, it is advisable to include the interlocking device as it rotates as one.

Meanwhile, the hook extension 45 rotates as it moves with the rotating part and it is advisable to be formed with the hook 45a on the side. The rotating part 40 can be formed as one with the hook extension 45.

To be more specific, when the protruding knob 41 is not operated, it stays in a restored state on one side with the elastic spring 43 placed in guide groove 12b as it can be seen in FIG. 5a. During this state, the hook 45a is equipped in the hook extension 45 restricts the support bar 15 within the insertion groove 12a which is formed within the housing wherein the plurality of support bars 15 maintain in the spread out form.

Long hole 42b is formed at the cover of the housing 12 at the back in order for protruding knob 41 to rotate.

It is advisable that the protruding knob 41 and protruding fixed knob 42b in the opposite direction to be placed on the rim of the long hole.

As it is seen in FIG. 5b, when the user applies the pressure to the protruding knob 41 and the fixed knob 42a by fastening it by pinching it together, the protruding knob 41 moves towards the fixed knob 42a through the long hole 42b wherein the rotating part 40 rotates as it is formed as one with it.

As this takes place, hook extension 45 that had been put in place to rotate together with the rotating part 40 rotates in the same direction wherein the hook 45a prepared with the hook extension 45 releases the restriction placed on the support bar 15. Due to this, the support bar 15 automatically folds as it escapes the insertion groove 12a through the elastic force of the elastic part (18 from FIG. 2) that had been previously mentioned.

As it had been illustrated, support bars 15 within the housing 12 are either restricted or freed by the restriction through the hook 45a of rotary control unit when the user operates the protruding knob 41 which is formed on the back of the housing 12. The rotating part 40 has shape of a circular ring and formed as one wherein hook extension 45 is equipped in multiple sections wherein the multiple hook extensions 45 either restrict or release the support bar at the same time when the user operates the protruding knob 41 in a simple manner.

Therefore, it is possible to provide clear and high quality lighting during the photography session when the picture of the subject is being taken for shadow will not form as there are no parts that will block the light from the light-emitting lamp (11 of FIG. 2) on the inside of the support bar 15.

As the rotary control unit that restricts the support bar is placed within the housing without taking up too much space, it minimizes the overall volume and the weight wherein it becomes more portable and easier to store.
This greatly improves the operability for portability and storage as it is possible to fold the support bars 15 easily to store it through the restoring force of the elastic part (18 of FIG. 2) as the support bars 15 are freed from restriction of the rotary control unit when the protruding knob 41 is operated by a simple manner.

The composition of lamp fixing unit with the reference to FIG. 3b is as follows.

As seen on FIG. 3b, the main components of the lamp fixing unit 20 are base part 21, hollow fixed part 25, and the supporting frame 33.

Base part 21 is connected to be selectively detachable at the back part of the housing 12 through the fastening part wherein the rim of the installation hole 22a is formed wherein the front part of the light-emitting lamp (11 of FIG. 2) at the center.

Therefore, plurality of base part with various types of rim of the installation hole 22a is prepared according to the type of the light-emitting lamp as they all have different shapes of the front part. Therefore, various types of light-emitting lamps can be applied interchangeably when the base part with rim of the installation hole 22a can be selected and combined together.

Moreover, hollow fixed part 25 which consists of hollow frame is formed on the both parts of the base part 12 wherein the fastening hole 26 is formed on the side of the hollow fixed part 25 where high pressure screw 26a.

Top part of the support frame 33 had been inserted in the hollow fixed part 25 in a detachable manner and the lower part is fixed to be selectively folded on the fastening equipment 80 where it is installed in the mounting post 13.

To be more specific, support frame 33 is shaped in a ‘ [symbol] ’ shape wherein the upper part fastened it is inserted into the hollow fixed part 25 through the high pressure screw 26a.

It is advisable that the handle made of synthetic resin would be connected at the lower part of the high pressure screw 26a.

Moreover, the lower part of the support frame 33 is placed so that it can gather together and be selectively fastened or released when it is inserted into the supporting equipment 80 or the folding hole 82. As such, the support frame 33 is equipped so that it can be gathered and folded.

When the light is to be used, the supporting equipment 80 is placed in the direction of the support frame 33 and fastened wherein it is stored by detaching the light-emitting lamp and the supporting frame 33 is folded by the standard of the folding hole 82 at the back as it can be stored in the housing as it is settled in the upper side of the supporting frame of the supporting equipment.

The lower side of the supporting equipment 80 can be fastened to the mounting post (13 of FIG. 2) which can be a tripod or other materials that can be used to adjust the height.

The present invention may, however, be embodied in different forms and should not be construed as limited to the embodiments set forth herein. Rather, these embodiments are provided so that this disclosure will be thorough and complete, and will fully convey the scope of the present invention to those skilled in the art.

### INDUSTRIAL APPLICABILITY

The present invention may be applicable to the industry as it provides the foldable soft box which has improved operability in terms of portability and storage.

What is claimed is:

1. A foldable soft box with lamp fixing unit that fixes the light-emitting lamp wherein it is connected in a detachable manner at the rim of the hollow portion comprising:
a housing in which a hollow portion is formed in the central part wherein a plurality of insertion grooves are radially formed on the front side with turning space is located at the inner part thereof;
a rotary control unit which is rotatably disposed in said turning space, and
wherein the rotary control unit has hooks which are elastically supported by elastic springs that are disposed in guide grooves formed on the inner side of said housing and selectively control said support bars inserted into said insertion grooves.

2. The foldable soft box of claim 1 wherein the rotary control unit is put in place in order to move in circumferential direction of the turning space wherein the rotating part with circular shape that had been equipped to be exposed at the outer part of the housing, and it rotates according to the rotating motion of the rotating part,
wherein it is formed with the hook extension part wherein the protruding hook is equipped.

3. The foldable soft box of claim 2 wherein long hole is formed at the back part of the housing for the purpose of protruding knob to go through and rotate; and
wherein the rim of the long hole is equipped with protruding knob and protruding fixed knob in the opposite direction to be placed on the rim of the long hole.

4. The foldable soft box of claim 1 wherein one side of the support bar and the housing are mutually connected by the elastic material wherein the folding action occurs when the support bar is freed from restriction.

5. The foldable soft box of claim 1 wherein the lamp fixing unit consists of the base part wherein the rim of the installed hole is formed which corresponds to the front part of the lamp in the center wherein it is connected selectively in a detachable manner through the fastening part located at the back part of the housing; and,
wherein the hollow portion placed at both sides of the base wherein the high pressure screw is fastened to the fastening hole at the side of the hollow frame;
wherein the higher portion is inserted to hollow fixed part and fastened in a detachable manner and the support frame that had been designed to selectively fold in the fixed equipment which is installed in the lower part of the mounting post.
